(19) United States
(12) Patent Application Publication
(10) Pub. No.: US 2009/0047938 A1
(43) Pub. Date: Feb. 19, 2009

(54) Media Handling for Multimedia Conferencing in Multihop Cellular Networks

(75) Inventors: Dhafer Ben Khedher, Montreal (CA); Roch Glitho, Saint-Laurent (CA); Rachida Dssouli, NDG (CA)

Correspondence Address: ERICSSON CANADA INC.;PATENT DEPARTMENT, 8400 DECARIE BLVD., TOWN MOUNT ROYAL, QC, H4P 2N2, CA

(73) Assignee: TELEFONAKTIEBOLAGET LM ERICSSON (PUBL), Stockholm (SE)

(21) Appl. No.: 11/840,088

(22) Filed: Aug. 16, 2007

(51) Int. Cl. H04M 3/42; G06F 15/16

(52) U.S. Cl. 455/416; 707/204

(57) ABSTRACT

An apparatus for controlling media handling in a multimedia conference between participants in a cellular network and participants in a mobile ad-hoc wireless network is disclosed. The disclosed multimedia conference mediator comprises a first interfacing unit for communicating with a media gateway controller in the mobile ad-hoc wireless network, a second interface for communicating with a media resource controller in a centralized media resource unit in the cellular network, and a mediator core configured to establish a media-bearing connection between a media mixer in the mobile ad-hoc wireless network and a media resource processor in the cellular network, using the media resource controller and the media gateway controller.

### BACKGROUND

1. Technical Field

The present invention relates generally to a media handling system. In particular, the present invention relates to an apparatus for controlling media handling in a multimedia conference between participants in a cellular network and participants in a mobile ad-hoc network.

2. Background

Although multi-hop wireless networks have been the subject of study for decades, attention has more recently turned to so-called Multihop Cellular Networks. Multihop Cellular Networks result from the linking of multihop mobile ad-hoc network models to conventional single-hop cellular networks, such as those conforming to specifications developed by the 3^{rd} Generation Partnership Project (3GPP). These hybrid networks offer enhanced flexibility and greater communications power compared to either network standing alone. However, linking these networks also raises new challenges for the seamless deployment of advanced multimedia applications.

Multimedia conferencing is just one important category of these advanced applications. Multimedia conferencing includes audio and video conferencing as well as multiparty gaming and scores of other interactive multimedia applications involving several users.

Multimedia conferencing generally consists of two distinct sub-sessions—call signaling and media handling. Call signaling includes the establishment, modification and tear down of call sessions, while media handling in conferences includes the setting up, controlling, and tearing down of media connections between participants, and the management of media components. Those media components include key components such as mixers, which receive media streams from multiple sources, combine them, and send the mixed streams to the participants. Other media components include bridges, gateways, controllers, transcoders, and so on.

In 3^{rd}-generation (3G) networks standardized by 3GPP, media handling functions are centralized in a system component called the Multimedia Resource Function (MRF), pictured in FIG. 1. MRF 110 comprises two functional entities: a media resource controller 115 (called a media resource function controller, or MRFC, in 3GPP standards) and a media resource processor 120 (called a media resource function processor, or MRFP, in 3GPP). The media resource controller 115 controls the media stream resources provided by the media resource processor 120. Under the direction of the media resource controller 115, the media resource processor 120 performs such functions as mixing incoming streams from multiple users (shown in FIG. 1 as user equipment 125), transcoding media streams, and handling “floor control” (managing of access rights to shared resources). In the 3GPP MRF, communication between the media resource controller and the media resource processor complies with the standard ITU-T H.248.1 Gateway Control Protocol, known as “Megaco/H.248” or simply “Megaco.”

The 3GPP MRF pictured in FIG. 1 receives instructions from an external application server 130, which hosts the conferencing application. Application server 130 handles conference booking, management of booking information, conference security, and so on. Users that wish to attend the conference establish a call with application server 130, e.g. by dialing a predetermined number; the application server then triggers the MRFC to create connection resources for the user. The application server 130 may also use its internal logic to set up a conference by triggering the MRFC to create connection resources for the user and to subsequently call the user. The application server 130 communicates indirectly with the media resource controller 115 via a session control function 140 (called Serving-Call Session Control Function, or S-CSCF, in 3GPP), which handles call signaling and routing services using Session Initiation Protocol (SIP).

In contrast to the centralized media handling in multimedia conferences on 3G networks, media handling in mobile ad-hoc networks (MANETs) is often distributed. Because there is generally no fixed infrastructure in a MANET, control functions and media processing functions are distributed among the MANET mobile user nodes. FIG. 2 illustrates an exemplary node. Mobile user node 210 comprises a media gateway controller 220, a media mixer 230, and a mobile conference application 240. Mobile user node 210 can be implemented on a wireless-equipped laptop computer, a mobile phone, or other device. Although mobile user nodes 210 are often portable devices, a fixed or generally stationary unit, such as a desktop computer, can also be configured as a mobile user node 210.

An exemplary architecture for distributed media handling in a MANET multimedia conference is illustrated in FIG. 3. The depicted architecture comprises three layers. At the lowest layer, user layer 330, are the individual mobile conference applications 240 residing on mobile user nodes. These mobile conference applications 240 correspond to the participants in the multimedia conference. Some, but not all, of the participating mobile user nodes also provide media mixer functionality at the second layer, media gateway layer 320. These media mixers 230 are fully meshed, in that each media mixer 230 sends media streams to the other media mixers 230. Each media conference application 240 in user layer 330 has a media-bearing connection with a media mixer 230 in the media gateway layer 320. The third layer, the control layer 310, comprises media gateway controllers 220 that command media mixers 230, assigning joining participants to media mixers 230, and otherwise managing the network. Not shown are signaling pathways between the media gateway controllers 220 and the mobile conference applications 240. These signaling pathways are used for call setup and media session setup, such as for establishing the media connections between the mobile conference applications 240 and their assigned media mixers 230.

As was shown in FIG. 2, a single mobile user node 210 may include functions operating at each of the three layers of FIG. 3. However, not all participating nodes provide media mixer or media gateway controller functionality. Nodes that provide neither, but simply participate as mobile conference applications 240 at user layer 330, are called simple nodes. These simple nodes may be capable of providing media mixer or media gateway control functionality, but those capabilities are disabled. As part of the management of the network, media gateway controllers 220 determine when to enable or disable media mixers 230 and additional media gateway controllers 220. Disabled functions in a capable node can become enabled at any time, and may be enabled dynamically in response to additional users joining a conference. Conversely, when users leave the conference, media mixers 230 and media gateway controllers 220 in other nodes may be disabled, so that their hosts become simple nodes.

Because control elements are generally distributed in a mobile ad-hoc network, while centralized in conventional cellular networks, media handling architectures will differ between the two. These differences are demonstrated in the exemplary architectures depicted in FIGS. 1 and 3. Thus, media handling in conferences involving participants from both types of networks raises unique challenges.

### SUMMARY

Various systems and apparatus for controlling media handling in a multimedia conference between participants in a cellular network and participants in a mobile ad-hoc wireless network (MANET) are disclosed. Among the cellular networks that may be supported by these systems are 3^{rd}-generation cellular networks, such as those defined by the 3^{rd}-Generation Partnership Project (3GPP).

One such apparatus is a multimedia conference mediator, comprising a first interfacing unit for communicating with a media gateway controller in the MANET, a second interfacing unit for communicating with a media resource controller in a centralized media resource unit in the cellular network, and a mediator core connected to each of the interfacing units and configured to establish a media-bearing connection between a media mixer function in the MANET and a media resource processor controlled by the media resource controller, using the media gateway controller and the media resource controller. The first and second interfacing units are configured to provide interfaces compatible with a MANET media gateway controller interface and a media control interface in the media resource controller, respectively.

Thus, from the MANET point of view, the media resource controller in the cellular network is made to appear as a MANET media gateway controller. Similarly, the MANET media gateway controller is made to appear to the media resource controller as a peer media resource controller. In one or more embodiments of the invention, the mediator core includes a protocol translator operative to translate first messages received from the MANET media gateway controller to second messages for the media resource controller in the centralized media resource unit.

In some embodiments of the invention, the multimedia conference mediator further comprises a conference gateway interface for communicating with a conference gateway controller. The mediator core establishes the media-bearing connection between the MANET media mixer and the media resource processor in the cellular network in response to one more multimedia session primitives received from the conference gateway controller.

Certain embodiments of the multimedia conference mediator comprise a media connection mediator, under the control of the mediator core, which is operative to receive multimedia traffic from the MANET media mixer function and from the media resource processor in the cellular network, and to translate between media streaming protocols used in the respective networks.

A media resource system for controlling media handling in a conference between at least one mobile terminal in a cellular network and a plurality of mobile user nodes in a MANET comprises a media resource processor configured to mix incoming media streams from the mobile terminal and a MANET media mixer, a media resource controller for controlling media stream resources within the media resource processor, a MANET interfacing unit for communicating with a media gateway controller in the MANET, and a mediator core connected to the MANET interfacing unit and configured to establish a media-bearing connection between the MANET media mixer function and the media resource processor, using the media resource controller and the media gateway controller. The MANET interfacing unit is configured to provide an interface compatible with a MANET media gateway controller interface.

An ad-hoc multimedia mediator node for controlling media handling in a conference between at least one mobile terminal in a cellular network and a plurality of mobile user nodes in a MANET comprises a MANET media mixer configured to mix incoming media streams from the mobile user nodes and a media stream from a media resource processor associated with the mobile terminal in the cellular network, a media gateway controller configured to control the MANET media mixer, a cellular network interfacing unit for communicating with a media resource controller in a centralized media switching unit in the cellular network, and a mediator core connected to the cellular network interfacing unit and configured to establish a media-bearing connection between the MANET media mixer and the media resource processor, using the media gateway controller and the media resource controller.

Of course, the present invention is not limited to the above features and advantages. Indeed, those skilled in the art will recognize additional features and advantages upon reading the following detailed description, and upon viewing the accompanying drawings.

### BRIEF DESCRIPTION OF THE DRAWINGS

FIG. 1 illustrates a media resource function providing media handling in a 3G network.

FIG. 2 is a block diagram of a mobile user node for use in a mobile ad-hoc wireless network.

FIG. 3 illustrates one example of an architecture for media handling in a mobile ad-hoc network.

FIG. 4 is a block diagram of media handling components in accordance with one or more embodiments of the invention.

FIG. 5 illustrates functional components of one embodiment of a multimedia conference mediator.

FIG. 6 illustrates exemplary media control signaling in a multimedia conference.

FIG. 7 illustrates another example of media control signaling in a multimedia conference.

FIG. 8 illustrates functional components of one embodiment of a media resource system.

FIG. 9 illustrates functional components of one embodiment of an ad-hoc multimedia mediator node.

### DETAILED DESCRIPTION

It should be understood that the following description, while indicating several embodiments of the invention, is given by way of illustration only. Various changes and modifications within the scope of the invention will become apparent to those skilled in the art. Furthermore, although the below discussion focuses on 3GPP networks and one or more possible mobile ad-hoc network architectures, those skilled in the art will recognize that the principles and devices described herein are readily applicable to a variety of cellular and mobile ad-hoc networks and network architectures.

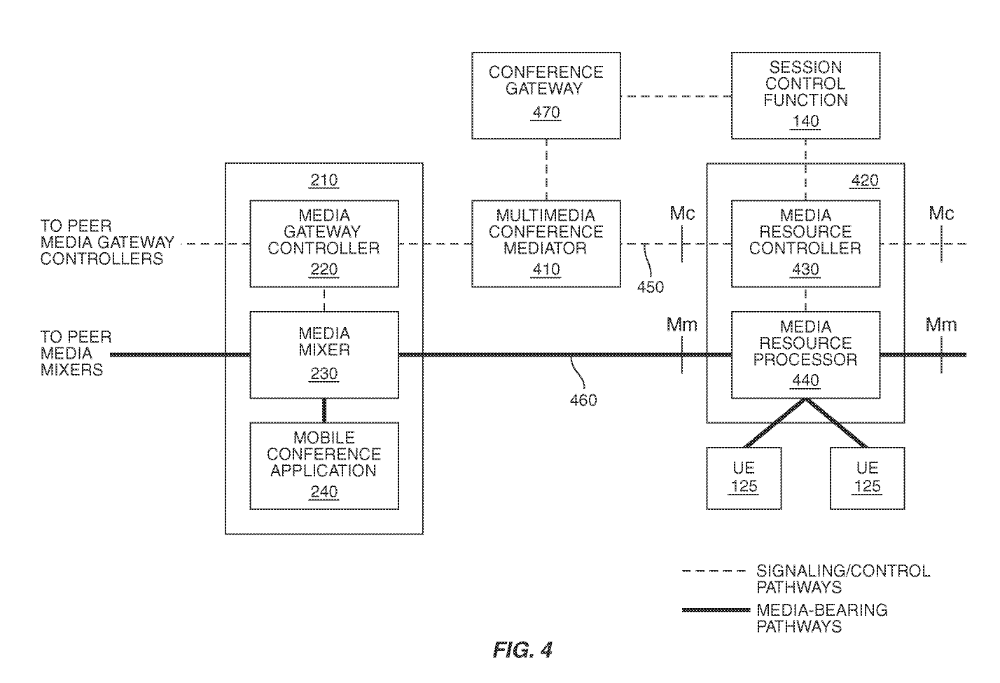

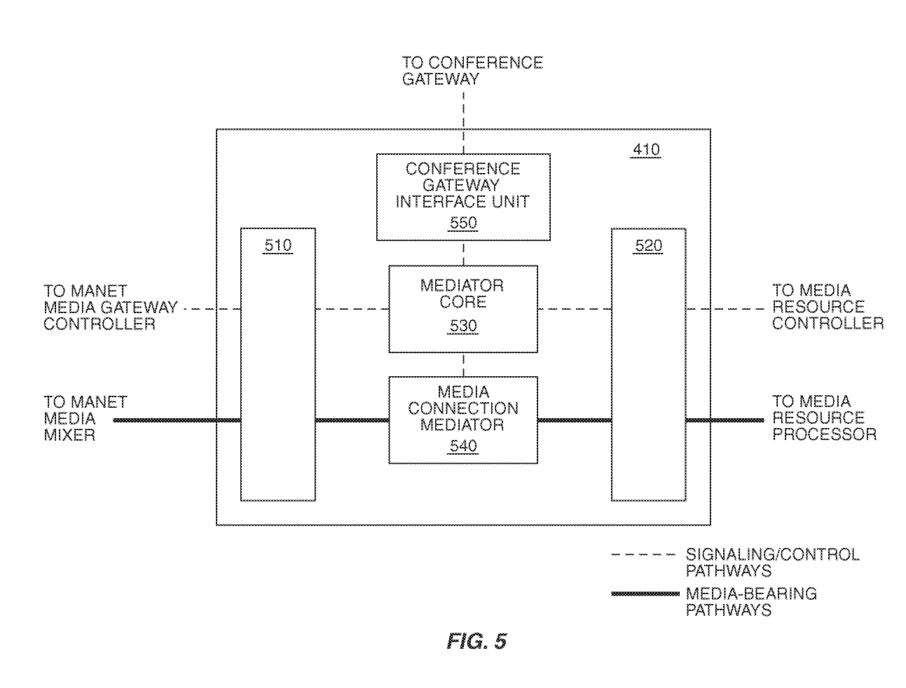

As discussed above, the linking of a mobile ad-hoc network (MANET) with a 3G cellular network creates challenges for the implementation of multimedia conferencing applications involving participants from both networks. FIG. 4 illustrates the linking of these two networks using a multimedia conference mediator 410 configured to address those challenges. With this approach, the operation of the two networks during a multimedia conference is largely independent, so that the performance of one is not affected by the network load of the other.

Using the methods and apparatus described herein, a MANET and a cellular network may be linked for purposes of multimedia conferencing, with minimal changes to either. Thus, from the MANET point of view, media resource controller 430 and media resource processor 440, components of the media resource function 420 in the 3G cellular network, are made to appear as MANET media gateway controllers and MANET media mixers, respectively. Similarly, using the approaches described herein, MANET media gateway controller 220 and MANET media mixer 230 appear as a peer media resource controller and peer media resource processor, respectively.

Media resource controllers 115 and media resource processors 120 used in conventional 3G cellular networks do not currently have interfaces with peer entities. Accordingly, as will be described in detail below, the 3GPP MRF is modified to provide a signaling link 450 between media resource controller 430 and multimedia conference mediator 410. This modification includes the extension of MRF protocols to facilitate peer-to-peer communication between one MRF and another; these same extended protocols are used for communication between media resource controller 430 and multimedia conference mediator 410. In particular, the protocol utilized between the MRFC and the MRFP is extended to support these new interfaces. Likewise, media resource processor 440 is provided with a new interface to permit a media-bearing connection 460 to media mixer 230.

These additional interfaces may be designed to permit the decentralization of conferencing in 3G cellular networks, facilitating conferencing with several media resource controllers 430 and several media resource processors 440 residing in one or more 3G cellular networks. Today, conferences may already be conducted with participants connected to more than one 3G cellular network. However, without these additional interfaces, all participants must establish connections to the same media resource function 420. As a result, media handling performance is limited by the resources of that single media resource 420, and will degrade as additional users join. Thus, these additional interfaces improve scalability. Furthermore, these additional interfaces permit interfacing with other types of networks as well as with media resource functions 420 in other 3G cellular networks.

As illustrated in FIG. 4, media resource controllers 430 and media resource processors 440 are configured with horizontal interfaces that allow them to communicate with peer entities, whether in the same or in dissimilar networks. The Mc reference point defines the interface between a media resource controller 430 and a peer controller. This interface allows two media resource controller peers to exchange messages to establish, control, and end media connections between media resource controllers 430. This interface also permits a media resource controller 430 in a cellular network to communicate with a media gateway controller 220, as will be discussed in detail below.

The protocol for the Mc interface between media resource controller peers may comply with the Megaco/H.248 protocol, using the same vocabulary and concepts that are currently used with Megaco/H.248, but extended to define messages between media resource controller peers rather than just between a controller and a mixer. For example, when a media resource controller 430 must make a media connection between its media resource processor 440 and a target media resource process 440 associated with a second media resource controller 430, it simply sends an “Add” command to the second media resource controller 430, which in turn commands the targeted media resource processor 440 to add the media connection. Reply messages are exchanged to finalize the operation.

The Mm interface permits two media resource processor peers to provide resources for the media connections between them. This interface also permits a media resource processor peer to connect to one or more media mixers 230 in a MANET, as well. In any event, this interface is used for media stream transport between media resource processor peers, using, for example, Real-time Transport Protocol (RTP) packets. Therefore, in decentralized environments, i.e. those employing more than one media resource processor 440, the media mixing operation is different than that deployed on conventional 3GCNs.

One example of how the mixing operation is performed can be described as follows: Suppose that users X and Y send media streams to a first media resource processor (MRP-1) and users U and V send media streams to a second (MRP-2). MRP-1 immediately mixes the streams from U and V and sends the result to MRP-2. MRP-2 in turn does the same thing with its entries from X and Y. When receiving the mixed result, MRP-2 performs a first mix by mixing the entry from MRP-1 with the stream of U and sends the result to V, and does a second mix by mixing the entry from MRP-1 with the stream of V and sends the result to U. MRP-1 performs the same process with its users. Thus, media streams received from a peer media resource processor, through interface Mm, are handled just as media streams from directly-connected UEs 125 are processed, even though the former may be previously mixed streams.

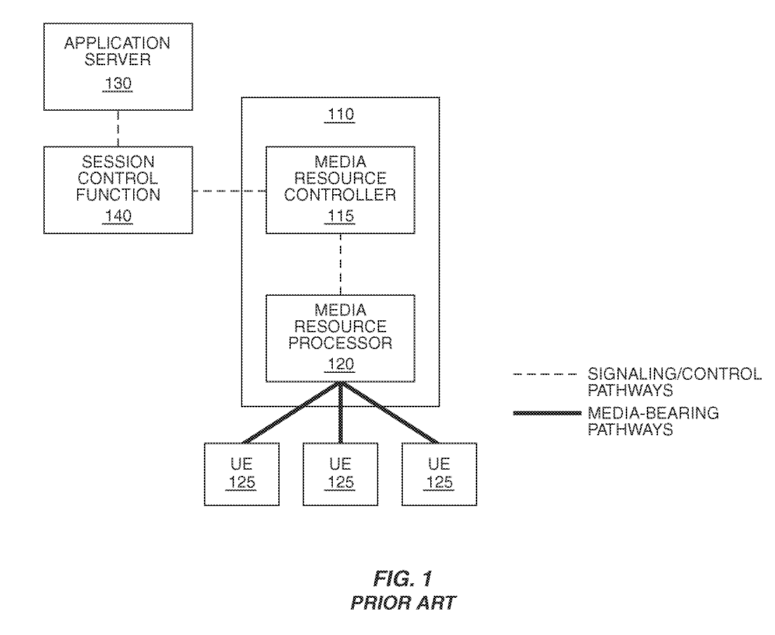

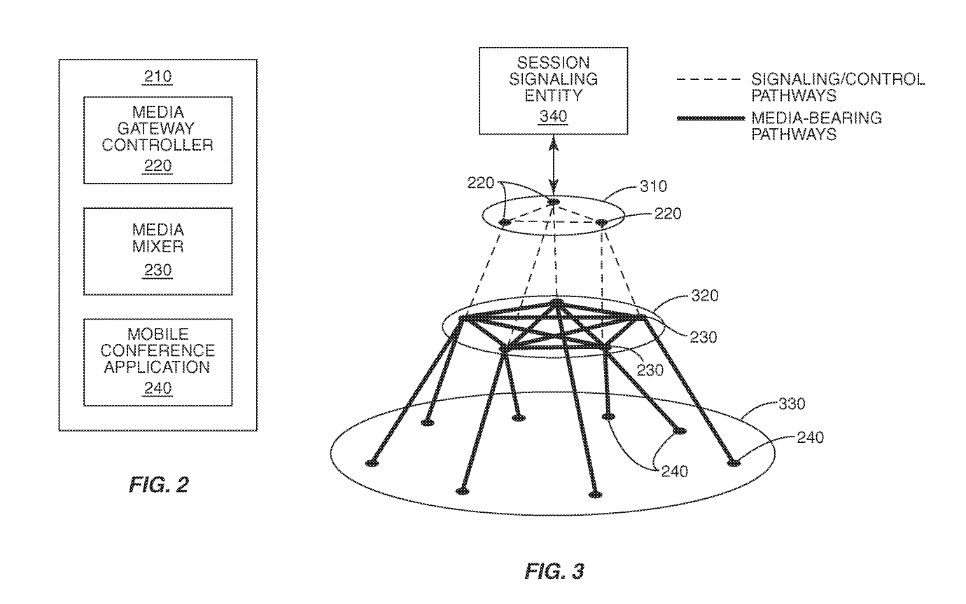

These new interfaces are also used to link the 3G cellular network's media resource function 420 with one or more MANET nodes 210, as shown in FIG. 4. Mediating between media resource function and 420 and MANET node 210 is multimedia conference mediator 410. In the exemplary embodiment of FIG. 4, multimedia conference mediator 410 directly mediates between media resource controller 430 and MANET media gateway controller 220. In this embodiment, media resource processor 440 is directly connected to MANET media mixer 230 using media-bearing connection 460, although, as will be shown, in some embodiments a mediator between media mixer 230 and media resource processor 440 is also required. Conference gateway 470 hosts the conferencing application, serving much the same role as the application server 130 discussed earlier in reference to FIG. 1. In the exemplary configuration of FIG. 4, conference gateway 470 communicates with media resource function 420 via session control function 140.

FIG. 5 illustrates functional components of one embodiment of a multimedia conference mediator 410. Mediator core 530 acts as a controller mediator between a 3G cellular network and a MANET. It assures connectivity between the networks, using MANET interfacing unit 510 and cellular network interfacing unit 520, and translates, as necessary, between the control protocols employed in the two networks. As will be discussed further below, the mediator core 530 can be deployed in the 3G cellular network, in a MANET node, or in a separate node operated externally to either network.

The mediator core 530 is required only when a multimedia conference includes users in both the 3G cellular network and the MANET. It is seen by MANET entities as a MANET media gateway controller 220 that controls media mixing functionality associated with conference participants in the 3G cellular network. Accordingly, it has all the capabilities of a MANET media gateway controller 220, and can control connectivity to media resource processors 440 in the 3G cellular network, which appear to the MANET as additional MANET media mixers 230.

From the point of view of the media resource function 420 in the 3G cellular network, on the other hand, the mediator core 530 entity is perceived by media resource controller 430 as a peer media resource controller, with which it can communicate using the Mc reference point. Thus, multimedia conference mediator 410 assures the independence of the 3G cellular network from the topologies and protocols used in the MANET.

If the 3G media resource processor 440 and the MANET media mixer 230 use different media streaming protocols, then media connection mediator 540 is used to translate between those protocols. Media connection mediator 540 may also be used when other media processing should be done when interfacing with between the 3G cellular network and the MANET. If media connection mediator 540 is used, then media bearing connections from MANET media mixer 230 and media resource processor 440 are routed to media connection mediator 540 using the MANET interfacing unit 510 and the cellular network interfacing unit 520, respectively.

The interface between mediator core 530 and media connection mediator 540 may be identical to that deployed between a media gateway controller 220 and a media mixer 230 in the MANET. In particular, this interface may employ the Megaco/H.248 protocol. When media processing is required at multimedia conference mediator 410, the mediator core 530 enables the media connection mediator 540 and sets up the necessary media connections to media resource processor 440 in the 3G cellular network and to the MANET media mixer 230, using the media gateway controller 230 in the MANET and the media resource controller 430 in the cellular network.

Use of the multimedia conference mediator 410 as described herein does not limit the topology of the MANET. In particular, media gateway controllers 220 and MANET media mixers 230 may still be connected to each other using a full mesh structure as earlier described. Indeed, media resources in both the 3G cellular network and the MANET can be configured using a variety of structures, such as hierarchies or trees.

Setting up call sessions between conference participants in the 3G cellular network and the MANET requires a call signaling system. Referring back to the exemplary configuration of FIG. 4, a conference gateway 470 handles call sessions for both sides. Conference gateway 470, which may be deployed by an operator of a 3G cellular system, acts as a mediator between the two networks with respect to setting up the conference. Conference gateway 470 has an infrastructure-based interface with the cellular network, and interfaces with one or more selected user agents in the MANET. It processes signaling protocols from both networks, and performs any required mapping and translation.

The conference gateway 470 may also provide publication and discovery services for the mobile user nodes 210 and/or the mobile conference applications 240 in the MANET. Thus configured, it periodically sends service advertisements to all nodes. A node that requires a particular service sends a discovery message through the network and waits for a response. Finally, conference gateway 470 also provides registration functions and manages the repository of MANET users.

Once call signaling has been established between users in the two networks, conference gateway 470 must discover a media gateway controller to make the necessary media connections. The discovery functionality consists of the ability to find a suitable media gateway controller 220 or multimedia conference mediator 410 that can connect the joining participant. In the embodiment illustrated in FIG. 4, the multimedia conference mediator 410 provides the media control functions, but other cases may involve several MANETs and several multimedia conference mediators. Thus, a generalized discovery approach may be needed. Furthermore, the discovery concept preserves independence between the call signaling protocol and the media handling protocol.

Referring once more to FIG. 5, multimedia conference mediator 410 includes a conference gateway interface unit 550, providing an interface to the conference gateway 470. Messaging between the conference gateway 470 and the mediator core 530 may be carried out using a set of primitives that allow conference gateway 470 to request the creation, modification, and termination of media sessions between participants in the 3G cellular network and the MANET. These primitives may include: create_session_request, create_session_confirm, connect-request, connect_confirm, disconnect_request, disconnect_confirm, modify_request and modify_confirm. These primitives are sent, along with the appropriate communications parameters, to establish and confirm call sessions, establish and confirm media connections for conference joiners, disconnect participants, and to modify the characteristics of a media connection.

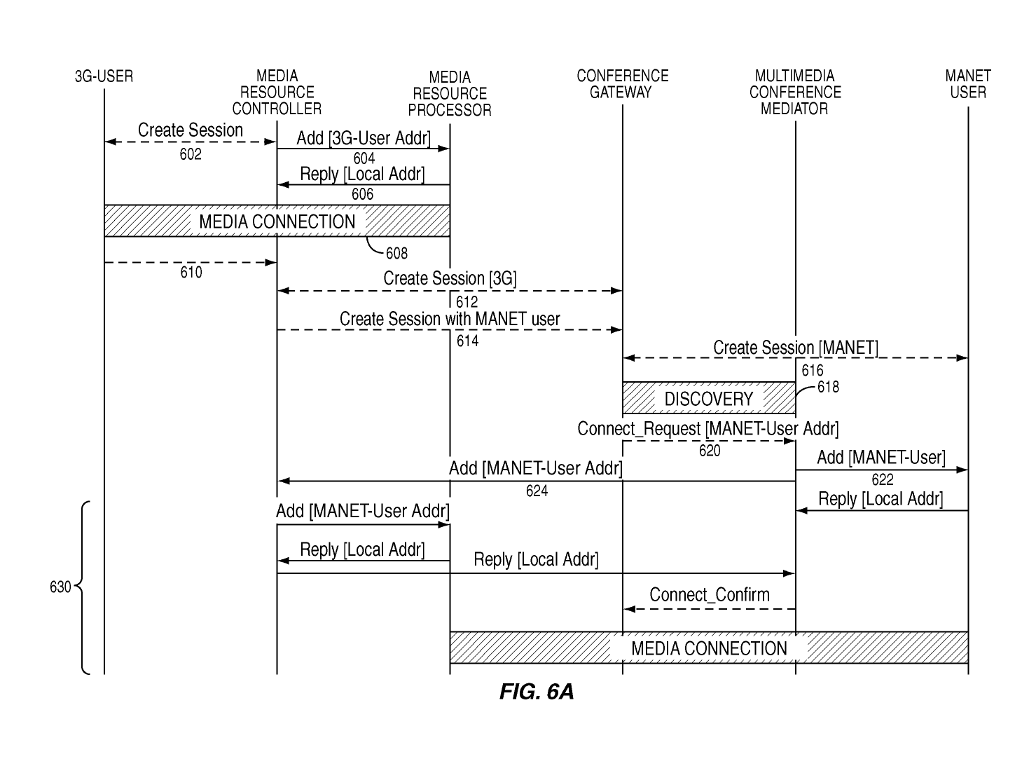

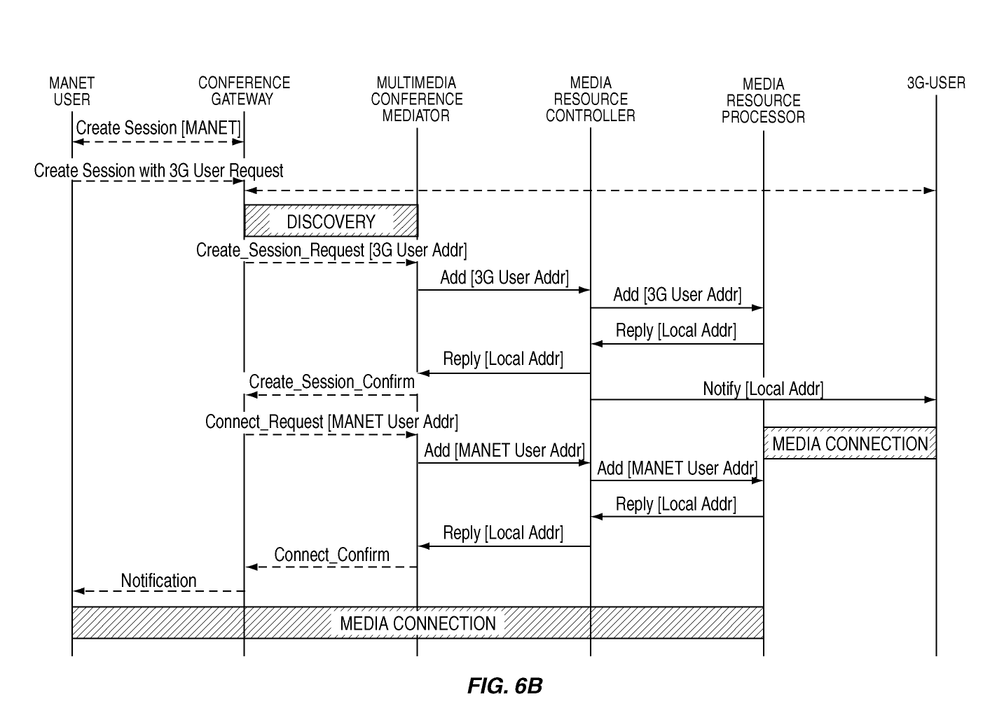

Using the components and systems described herein, a user in either of the MANET or cellular networks may initiate a multimedia conference. Four scenarios are possible for starting a conference involving participants in both networks: a cellular network user initiates the conference with a MANET user, a MANET user initiates the conference with a cellular network user, a cellular network user invites a MANET user to a pre-existing cellular network multimedia conference, and a MANET user invites a cellular network user to a pre-existing conference. FIG. 6 depicts exemplary conference initiation sequences between a MANET user and a 3G cellular network user according to one or more embodiments of the invention.

In FIG. 6A, 3G-User initiates a multimedia conference with MANET-User. It first creates a 3G call session at 602. At 604, media resource controller 430 creates a new local context, adds a new termination corresponding to 3G-User to the local context, and returns a Local Connection Address to 3G-User at 606, as in the 3GPP standard. Thus, a media connection is established at 608 between 3G-User and media resource processor 440. Next, 3G-User requests the creation of a call signaling session with MANET-User at 610. At 612 and 614, a call signaling session with the conference gateway 470 is established; the conference gateway 470 in turn creates a call signaling session with MANET-User at 616. Consequently, the conference gateway 470 will discover, at 618, multimedia conference mediator 410, which is the gateway mediator to MANET-User, and then send a connect-request primitive to connect the MANET-User to the conference at 620. At 622, the multimedia conference mediator 410 in turn requests the MANET-User to start a media mixer 230 for itself by creating a new local context and adding a termination for itself. At 624, multimedia conference mediator 410 initiates a connection between the MANET-User and media resource processor 440 by signaling media resource controller 430. The media connection is established at 630. As a result, an end-to-end media connection is established between 3G-User and MANET-User, via media resource processor 440.

It should be noted that the above description of a multimedia conference initiation assumes that the media mixer function 230 at MANET-User is able to establish a media connection directly to media resource processor 440. As discussed above, if different media transport protocols are used, then the media connection will instead be routed through a media connection mediator 540 at the multimedia conference mediator 410 for translation or transcoding.

FIG. 6B illustrates a multimedia conference setup procedure initiated by the MANET user. Those skilled in the art will readily appreciate the similarities between the signaling and media flows depicted in FIGS. 6A and 6B. In both cases, the multimedia conference mediator 410, specifically the mediator core 530, translates protocols and maps addresses between the two networks. The multimedia conference mediator 410 thus acts as a media gateway controller for MANET users and provides media resource control functionality for the 3G users.

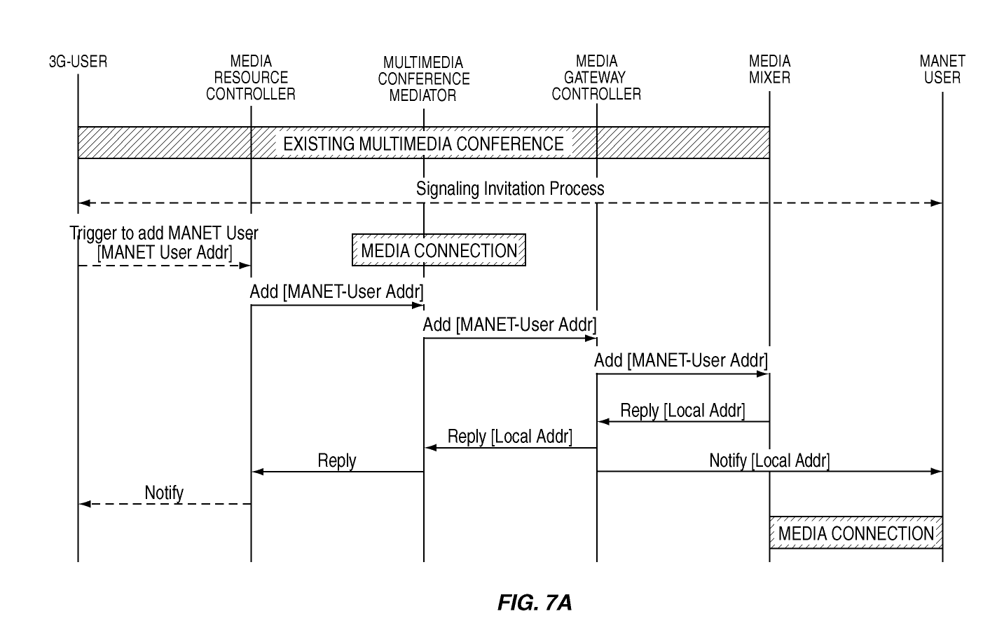

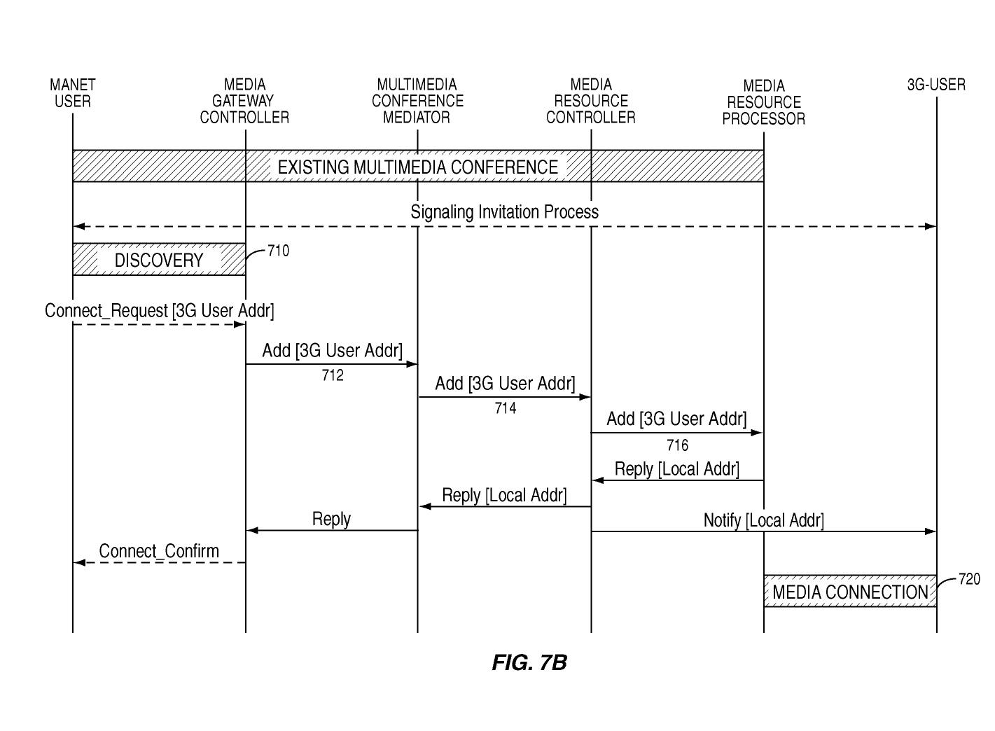

Once a multimedia conference is established between cellular network users and MANET users, additional users can be invited. A cellular network user that wishes to invite a MAN ET user first establishes call signaling to it. In response, the media resource controller 430 is triggered to add the MANET user. FIG. 7A illustrates an example signal flow for the scenario of a 3G user inviting a MANET user.

FIG. 7B illustrates the corresponding scenario for an invitation of a 3G user by a MANET user. In this scenario, MANET-User sets up the call signaling with 3G-User and then discovers, at 710, a media gateway controller 220 to initiate a media connection between 3G-User and the conference. The discovered media gateway controller 220 determines that the invited user is in the 3G cellular network, and then requests multimedia conference mediator 410 to add 3G-User to the conference at 712. Multimedia conference mediator 410 relays the request to the media resource controller 430 at 714, which in turn requests the media resource processor 440 to add a new termination for 3G-User in the local context of the conference at 716. Thus, a media connection between 3G-User and media resource processor 440 is established at 720.

Those skilled in the art will appreciate that the conference initiation and invitation procedures described above are merely exemplary, and that various modifications and extensions of these procedures are possible. Those skilled in the art will also recognize that the functional components of the multimedia conference mediator 410 described herein may be deployed in a number of different configurations, depending on the network structures, operator business models, and other factors.

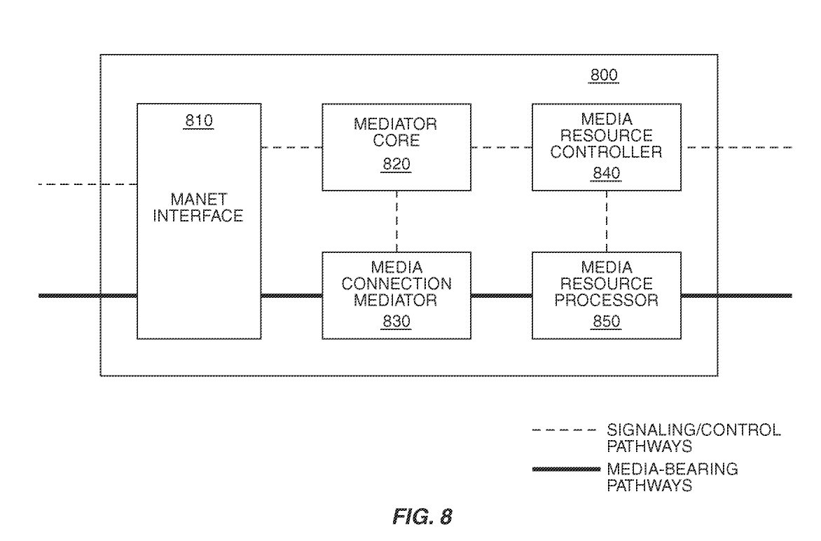

One such configuration is depicted in FIG. 8. In one or more embodiments, media resource system 800 may be deployed in a 3G cellular network, replacing a conventional media resource function. In media resource system 800, mediator core 820 and media connection mediator 830 are tightly coupled to media resource controller 840 and media resource processor 850. Each of these functional units provides the same functionality above. MANET interface 810 provides an interface to one or more MANET media gateway controllers 220 and one or more MANET media mixers 230, as previously described. Because of the tight coupling between mediator core 820 and the media resource controller 840, a distinct cellular network interfacing unit may not be required.

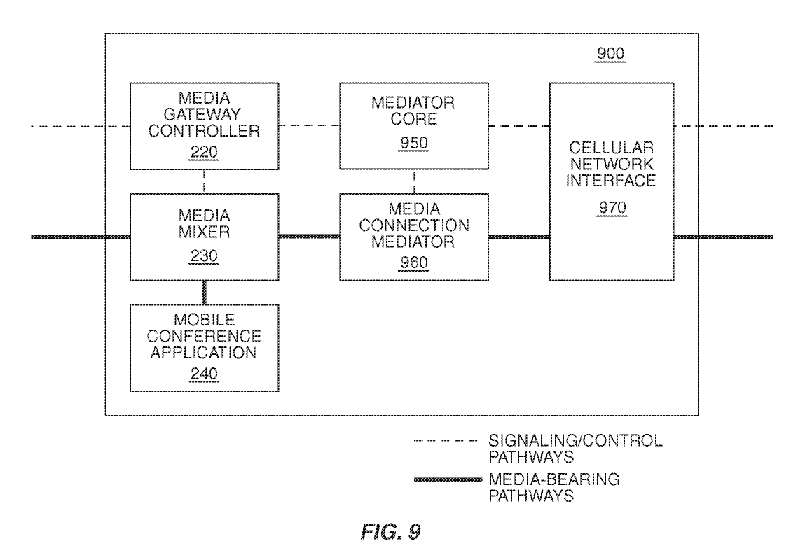

Another configuration is depicted in FIG. 9. In this configuration, an ad-hoc multimedia mediator node 900 includes a media gateway controller 220, a media mixer 230, and a mobile conference application 240, each providing the functionality previously described. Thus, multimedia mediator node 900 is configured to provide one element of a distributed media gateway controller function in a MANET, as well as a MANET media mixer 230 that can be meshed with other media mixers in the MANET.

Ad-hoc multimedia mediator node 900 also comprises a mediator core 950 and media connection mediator 960. These provide the same control, translation, and processing functions earlier described. Finally, ad-hoc multimedia mediator node 900 comprises a cellular network interface 970, facilitating connections to one or more media resource controllers 430 and media resource processors 440 in a cellular network.

The multimedia mediator node 900 thus allows the multimedia conference mediator functionality to be deployed at a node in the MANET. The mediator functionality may be enabled when a conference between 3G and MANET participants is first established, or when a participant from the other network is first invited to a one-network multimedia conference. Those skilled in the art will appreciate that the same mechanisms used to enable and disable new media gateway controllers and media mixers in the MANET may also be employed to enable and disable the multimedia mediator functions of mediator core 950 and media connection mediator 960.

Those skilled in the art will immediately appreciate that all of the functional units described herein, including the mediator core 530, media connection mediator 540, MANET interfacing unit 510, cellular network interfacing unit 520, media resource controller 430, media resource processor 440, media mixer 230, and media gateway control 220, may be implemented by computer program instructions and/or hardware operations. The same, of course, applies to the illustrated variants of these functional blocks, including MANET interface 810, mediator core 820, media connection 830, media resource controller 840, media resource processor 850, mediator core 950, media connection mediator 960, and cellular network interface 970. These computer program instructions may be provided to a processor of a general purpose computer, a special purpose computer, or other programmable data processing apparatus to produce a machine, such that the instructions, which execute via the processor of the computer or other programmable data processing apparatus, create means for implementing the functions described herein and illustrated in the accompanying block diagrams and flow diagrams.

These computer program instructions may also be stored in a computer usable or computer-readable memory that may direct a computer or other programmable data processing apparatus to function in a particular manner, such that the instructions stored in the computer usable or computer-readable memory produce an article of manufacture including instructions that implement the functions described herein. Several of the functional entities described herein may be implemented together on a single processor or computer, or each may be implemented on separate processors or computers. Those skilled in the art will recognize the advantages and disadvantages of grouping or distributing the functions described herein.

With these and other variations and extensions in mind, those skilled in the art will appreciate that the foregoing description and the accompanying drawings represent non-limiting examples of the systems and apparatus taught herein for controlling media handling in a conference between participants in a cellular network and a mobile ad-hoc network. As such, the present invention is not limited by the foregoing description and accompanying drawings. Instead, the present invention is limited only by the following claims and their legal equivalents.

What is claimed is:

1. A multimedia conference mediator for controlling media handling in a conference between at least one mobile terminal in a cellular network and a plurality of mobile user nodes in a mobile ad-hoc network (MANET), wherein at least one of the mobile user nodes comprises a MANET media mixer and a media gateway controller, the multimedia conference mediator comprising:
a MANET interfacing unit, compatible with a MANET media gateway controller interface, for communicating with the media gateway controller;
a cellular network interfacing unit, compatible with a cellular network media control interface, for communicating with a media resource controller in a centralized media resource unit in the cellular network; and
a mediator core connected to the MANET interfacing unit and the cellular network interfacing unit and configured to establish a media-bearing connection between the MANET media mixer and a media resource processor in the cellular network using the media resource controller and the media gateway controller.

2. The multimedia conference mediator of claim 1, wherein the centralized media resource unit comprises a Multimedia Resource Function in a 3G cellular network.

3. The multimedia conference mediator of claim 2, wherein the cellular network media control interface comprises an extended Multimedia Resource Function protocol designed to facilitate peer-to-peer communication between the Multimedia Resource Function and peer Multimedia Resource Functions.

4. The multimedia conference mediator of claim 3, wherein the extended Multimedia Resource Function protocol is based on the Megaco/H.248 protocol.

5. The multimedia conference mediator of claim 1, wherein the mediator core comprises a protocol translator operative to translate first messages received from the media gateway controller via the MANET interfacing unit to second messages for sending to the media resource controller via the cellular network interfacing unit.

6. The multimedia conference mediator of claim 1, further comprising a conference gateway interface providing an interface to a conference gateway controller, wherein the mediator core establishes the media-bearing connection in response to one or more multimedia session primitives received from the conference gateway controller.

7. The multimedia conference mediator of claim 1, further comprising a media connection mediator under the control of the mediator core and operative to receive multimedia traffic from the MANET media mixer and the media resource processor in the cellular network and to translate between media streaming protocols used in the MANET and cellular network.

8. The multimedia conference mediator of claim 7, wherein the media streaming protocols include the Real-Time Transport Protocol.

9. A media resource system for controlling media handling in a conference between at least one mobile terminal in a cellular network and a plurality of mobile user nodes in a mobile ad-hoc network (MANET), wherein at least one of the mobile user nodes comprises a MANET media mixer and a media gateway controller, the media resource unit comprising:
a media resource processor configured to mix incoming media streams from the at least one mobile terminal and the MANET media mixer;
a media resource controller for controlling media stream resources within the media resource processor;
a MANET interfacing unit, compatible with a MANET media gateway controller interface, for communicating with the media gateway controller; and
a mediator core connected to the MANET interfacing unit and configured to establish a media-bearing connection between the MANET media mixer and the media resource processor using the media resource controller and the media gateway controller.

10. The media resource system of claim 9, wherein the media resource processor comprises a Media Resource Function Processor in a 3G network and wherein the media resource controller comprises a Media Resource Function Controller in the 3G network.

11. The media resource system of claim 10, wherein the Media Resource Function Controller is configured to communicate with peer Media Resource Function Controllers using an extended Multimedia Resource Function protocol, and wherein the mediator core is configured to communicate with the Media Resource Function Controller using the extended Multimedia Resource Function protocol.

12. The media resource system of claim 11, wherein the extended Multimedia Resource Function protocol is based on the Megaco/H.248 protocol.

13. The media resource system of claim 9, wherein the mediator core comprises a protocol translator operative to translate first messages received from the media gateway controller via the MANET interfacing unit to second messages for sending to the media resource controller.

14. The media resource system of claim 9, wherein the mediator core is further configured to communicate with a conference gateway controller and to establish the media-bearing connection in response to one or more multimedia session primitives received from the conference gateway controller.

15. The media resource system of claim 9, further comprising a media connection mediator under the control of the mediator core and operative to receive multimedia traffic from the MANET media mixer and from the media resource processor and to translate between media streaming protocols used in the MANET and cellular network.

16. An ad-hoc multimedia mediator node for controlling media handling in a conference between at least one mobile terminal in a cellular network and a plurality of mobile user nodes in a mobile ad-hoc network (MANET), comprising:
a MANET media mixer configured to mix incoming media streams from the plurality of mobile user nodes and a media stream from a media resource processor in the cellular network;
a media gateway controller configured to control the MANET media mixer;
a cellular network interfacing unit, compatible with a cellular network media control interface, for communicating with a media resource controller in a centralized media switching unit in the cellular network; and
a mediator core connected to the cellular network interfacing unit and configured to establish a media-bearing connection between the MANET media mixer and the media resource processor using the media gateway controller and the media resource controller.

17. The ad-hoc multimedia mediator node of claim 16, wherein the mediator core comprises a protocol translator operative to translate first messages received from the media resource controller via the cellular network interfacing unit to second messages for sending to the media gateway controller.

18. The ad-hoc multimedia mediator node of claim 16, further comprising a conference gateway interface providing an interface to a conference gateway controller, wherein the mediator core establishes the media-bearing connection in response to one or more multimedia session primitives received from the conference gateway controller.

19. The ad-hoc multimedia mediator node of claim 16, further comprising a media connection mediator under the control of the mediator core and operative to receive multimedia traffic from the media mixer and the media resource processor and to translate between media streaming protocols used in the MANET and cellular network.
